(19) United States
(12) Patent Application Publication
(10) Pub. No.: US 2003/0014154 A1
(43) Pub. Date: Jan. 16, 2003

(54) Equipment for the transfer of workpieces

(76) Inventors: Bruno Fischer, Oetwil (CH); Markus Klingler, Niederhasli (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 10/191,712

(22) Filed: Jul. 9, 2002

(30) Foreign Application Priority Data
Jul. 9, 2001 (EP) 01810678

(51) Int. Cl. G06F 7/00

(52) U.S. Cl. 700/213

(57) ABSTRACT

In a production line, small parts or conductor ends are transported by means of workpiece carriers from work station to work station. First and second transfer devices and an interchange device move the workpiece carriers from work station to work station. The devices each consists of a support unit and a belt module. The belt module is inserted from above into the support unit, wherein slots of a wheel axle and dogs of a pulley axle are vertically aligned. The dogs then fit into the slots, and a gearwheel of the belt module is coupled with the transfer drive. The belt module can be inserted or removed without demounting the transfer drive.

The present invention relates to equipment for the transfer of workpieces by means of workpiece carriers within a production line with at least one first group of work stations, wherein the workpiece carriers are movable by means of at least one transfer device.

### BACKGROUND OF THE INVENTION

A transfer device in which workpieces are transported by means of workpiece carriers from work station to work station of a production line has become known from laid-open specification DE 198 26 627 A1. The work stations are arranged in a line and provided with assembly devices and/or processing devices. A first group of work stations executes time-intensive work procedures and a second group of work stations executes less time-intensive work procedures, wherein the first group is disposed upstream of the second group with respect to the direction of production workflow. A first transfer device moves the workpiece carriers from work station to work station of the first group. A second transfer device moves the workpiece carriers from work station to work station of the second group. An interchange device is connected between the two transfer devices, wherein the first transfer device hands over the workpiece carriers to the interchange device and the interchange device feeds the workpiece carriers to the second transfer device. The workpiece carriers pass from the first transfer device to a transport belt of the interchange device, wherein the transport belt prepositions the workpiece carriers in that the workpiece carriers are moved up to a retaining element. At the entry side the second transfer device has a coupling section which, by means of a stroke movement, grips a workpiece carrier at a toothed profile at the base side and passes it on to a belt drive. The stroke movement of the coupling section is derived from a control shaft for the work stations of the second group.

A disadvantage of the known equipment resides in the fact that wear parts such as flat belts, cogged belts, parts of the tension device, etc., can be exchanged only with considerable demounting effort and assembly effort.

### BRIEF DESCRIPTION OF THE INVENTION

Here the invention will create a remedy. The invention, as characterised in claim 1, meets the object of avoiding the disadvantages of the known equipment and of creating a maintenance-friendly transfer device.

Advantageous developments of the invention are indicated in the dependent claims.

The advantages achieved by the invention are essentially to be seen in that the wear parts such as cogged belts or bearings can be exchanged with little effort. No special knowledge is necessary for maintenance operations. The wear parts are integrated in exchange elements of modular form. Short standstill times of the entire production plant can be realised by the equipment according to the invention, which in turn has a positive effect on productivity. Moreover, the equipment for the transfer of the workpiece carriers can be constructed substantially more simply in mechanical terms, which in turn has a favourable effect on the production costs of the production plant. In addition, the equipment manages with few wear parts, which increases reliability and reduces maintenance expenditure.

### BRIEF DESCRIPTION OF THE DRAWINGS

The present invention is explained in more detail in the following description with reference to the accompanying figures, in which:

FIG. 1 shows a production line with work stations and equipment for the transfer of workpiece carriers in accordance with the invention;

FIG. 2 shows a first transfer device, an interchange device and a second transfer device with the associated drive motors and sensors for detecting the position of the workpiece carriers or the gearwheel setting as used in the production line of FIG. 1;

FIG. 3 shows a schematic illustration of a workpiece carrier in the handover from a transfer device to the interchange device or in the handover from the interchange device to a transfer device;

FIG. 4 shows a view from below of a support unit for the transfer device or for the interchange device;

FIG. 5 shows a side view of the support unit,

FIG. 6 shows a side view of a belt module with a check member removed for clarity;

FIG. 7 shows a plan view of the belt module;

FIG. 8 shows a section through a gearwheel;

FIG. 9 shows a transfer drive or an interchange drive;

FIG. 10 shows a deflecting wheel of a belt drive for the return run of the workpiece carriers; and

FIGS. 11 and 12 show, respectively, a side and a plan view of a coupling device for transmission of the belt movement of the transfer device to an extension.

### DETAILED DESCRIPTION OF THE INVENTION

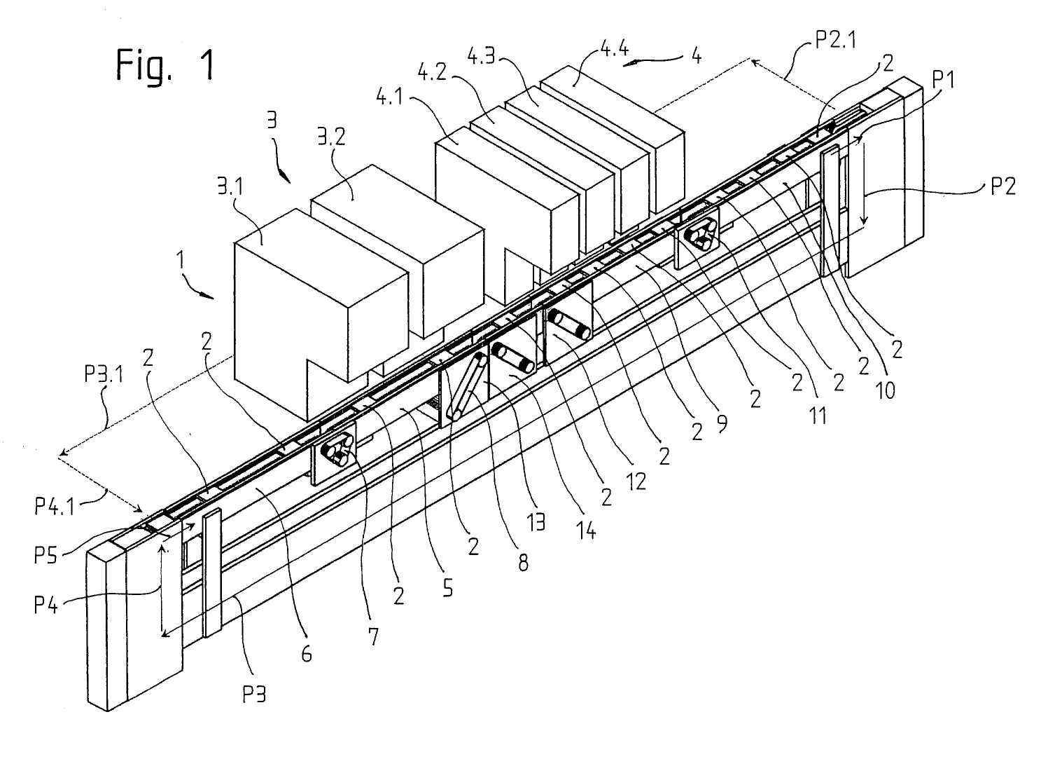

FIG. 1 shows a production line for the processing of workpieces, for example small parts or conductor ends, which are transported by means of workpiece carriers 2 from work station to work station. The production direction is symbolized by an arrow P0. The workstations are arranged in a line and provided with assembly devices and/or processing devices, wherein a first work station group 3 with large work stations 3.1, 3.2 and a second work station group 4 with small work stations 4.1, 4.2, 4.3, 4.4 are provided. The first group 3 causes a large spacing between workpiece carriers 2 (large pitch dimension) and the second group 4 causes a small spacing between workpiece carriers 2 (small pitch dimension). In the illustrated embodiment the first group 3 of work stations 3.1, 3.2 executes less time-intensive working procedures than the second group 4 of work stations 4.1, 4.2, 4.3, 4.4. The work procedures of the first group 3 can also be equally time-intensive or more time-intensive than the work procedures of the second group 4.

A first transfer device 5 and a first extension 6 move the workpiece carriers 2 from work station to work station of the first group 3, wherein the first transfer device 5 mechanically drives the first extension 6 by means of a first coupling device 7. A first transfer drive 8 drives the first transfer device 5.

A second transfer device 9 and a second extension 10 move the workpiece carriers 2 from work station to work station of the second group 4, wherein the second transfer device 9 mechanically drives the second extension 10 by means of a second coupling device 11. A second transfer drive 12 drives the second transfer device 9.

By use of the extensions 6, 10 the belt drives of the transfer devices 5, 9 are not too long, and belt elasticity is thus minimized, so as to have a positive effect on the positional accuracy of the workpiece carriers 2.

A transfer device, denoted as interchange device 13, with an interchange drive 14 is connected between the two transfer devices 5, 9, wherein the first transfer device 5 hands over the workpiece carriers to the interchange device 13 and the interchange device 13 feeds the workpiece carriers 2 to the second transfer device 9. The interchange device 13 serves as an adapter for the different pitch dimensions of the first work station group 3 and the second work station group 4. If more than two groups of work stations are provided, more than two transfer devices and more than one interchange device are also provided.

The return run of the workpiece carriers 2 is symbolized by arrows P1, P2, P3, P4 and P5, wherein P1, P3, P5 are, for example, horizontal belt drives and P2 and, P4 are vertical conveyors for the workpiece carriers 2. As a variant, the return run of the workpiece carriers 2 can take place exclusively in a horizontal plane. This return run variant is symbolized by the arrows P1, P2.1, P3.1, P4.1 and P5.

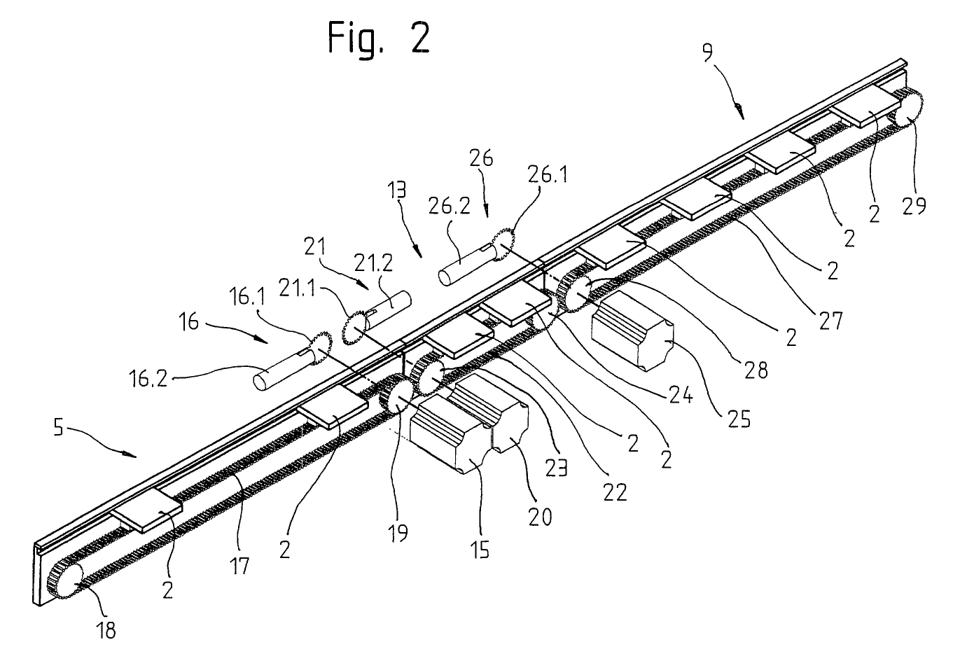

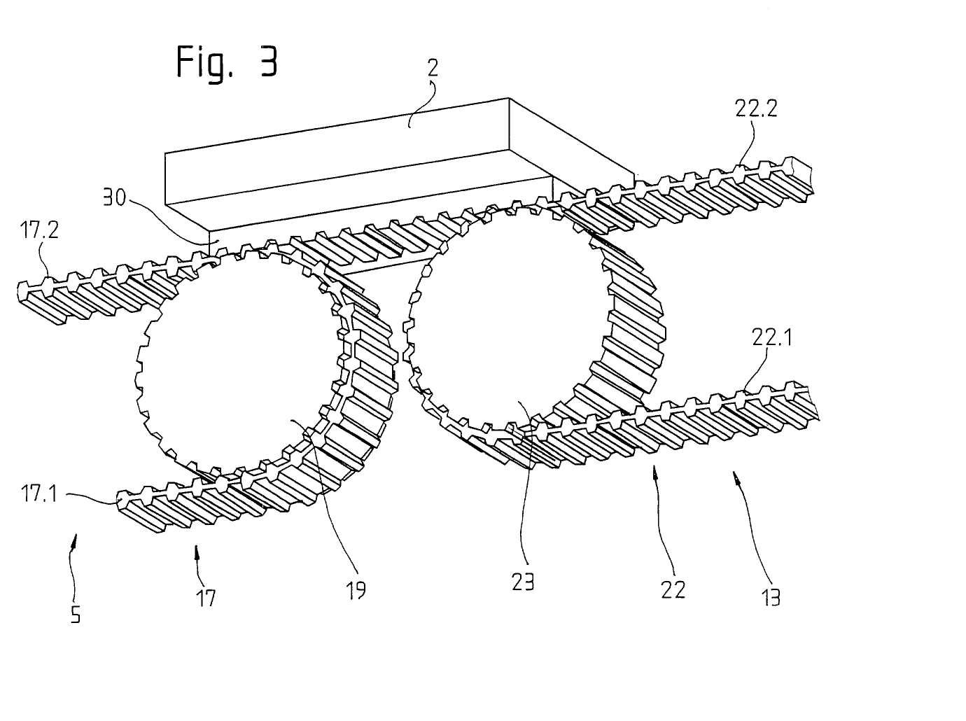

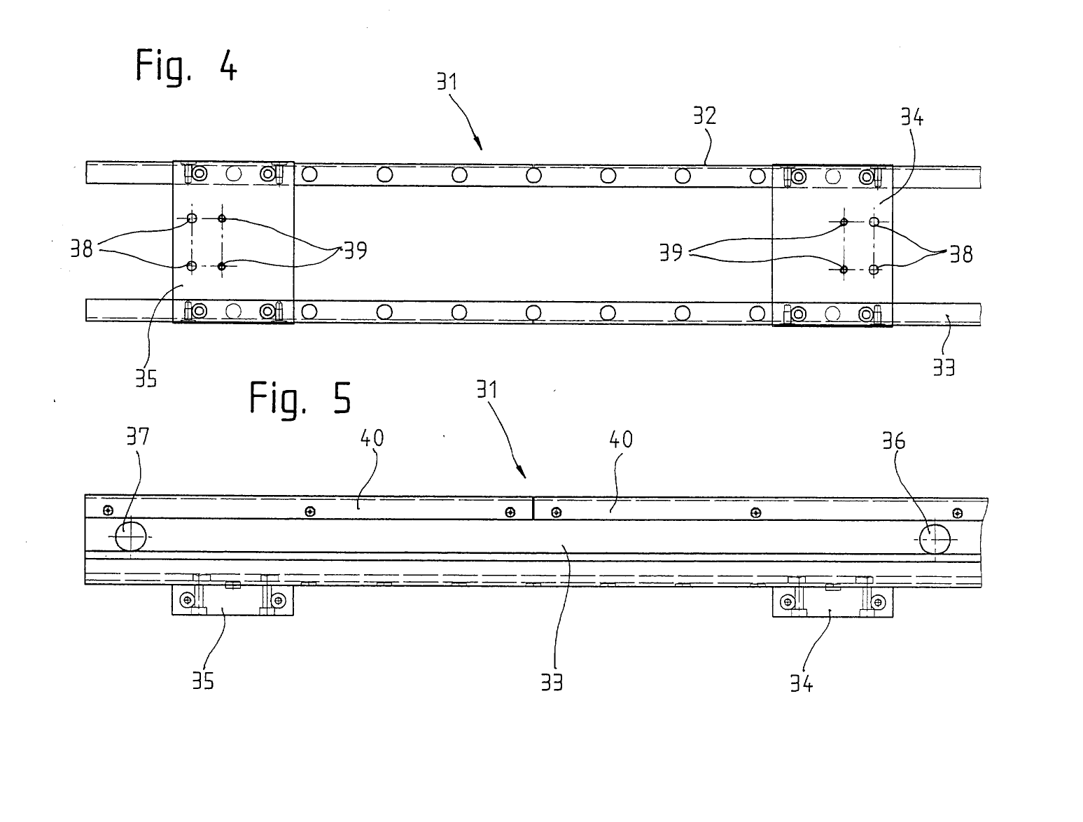

FIG. 2 shows the first transfer device 5 with a first drive motor 15, a first sensor 16 and a first double-sided cogged belt 17, which is deflected by means of a first gearwheel 18 and a second gearwheel 19, wherein the first drive motor 15 acts on the second gearwheel 19. The first sensor 16 consists of a first toothed disc 16.1, which images the teeth of the second gearwheel 19, and a first scanner 16.2, which detects the teeth of the rotating first toothed disc 16.1. The first transport device 5 is shown as transporting two workpiece carriers 2.

FIG. 2 also shows the interchange device 13 with a second drive motor 20, a second sensor 21 and a second double-sided cogged belt 22, which is deflected by means of a third gearwheel 23 and a fourth gearwheel 24, wherein the second drive motor 20 acts on the third gearwheel 23. The second sensor 21 consists of a second toothed disc 21.1, which images the teeth of the third gearwheel 23, and a second scanner 21.2, which detects the teeth of the rotating second toothed disc 21.1. The interchange device 13 is shown as transporting two workpiece carriers 2.

FIG. 2 further shows the second transfer device 9 with a third drive motor 25, a third sensor 26 and a third double-sided cogged belt 27, which is deflected by means of a fifth gearwheel 28 and a sixth gearwheel 29, wherein the third drive motor 25 acts on the fifth gearwheel 28. The third sensor 26 consists of a third toothed disc 26.1, which images the teeth of the fifth gearwheel 28, and of a third scanner 26.2, which detects the teeth of the rotating third toothed disc 26.1. The second transfer device 9 is shown as transporting four workpiece carriers 2.

FIG. 3 shows a schematic illustration of a workpiece carrier 2 during a handover from the first transfer device 5 to the interchange device 13 or during a handover from the interchange device 13 to the second transfer device 9. The double-sided first cogged belt 17 of the first transfer device 5 serves as a transport means for the workpiece carriers 2, wherein the teeth 17.1 of one belt side engage the gearwheels 18, 19 and the teeth 17.2 of the other belt side engage a toothed profile 30 arranged at the underside of the workpiece carrier 2. The double-sided second cogged belt 22 of the transfer device 13 similarly serves as a transport means for the workpiece carriers 2, wherein the teeth 22.1 of one belt side engage the gearwheels 23, 24 and the teeth 22.2 of the other belt side engage in the toothed profile 30 arranged at the underside of the workpiece carrier 2. The same applies to the handover of the workpiece carrier 2 from the interchange device 13 to the second transfer device 5. The transport of the workpiece carrier 2 in the production direction P0 thus takes place exclusively by the mechanically positive coupling between the cogged belts 17, 22, 27 and the workpiece carrier 2 without mechanical coupling between the first transfer device 5 and the interchange device 13 or between the interchange device 13 and the second transfer device 9.

The equipment illustrated in the following refers, by the reference numerals, to the first transfer device 5. The second transfer device 9 or the interchange device 13 is constructed in mechanically comparable manner with the first transfer device 5.

FIG. 4 and FIG. 5 show a support unit 31 of the transfer device 5, 9 or the interchange device 13. The support unit 31 determines the length of the transfer device 5, 9 or of the interchange device 13. In a further variant there can also be provided only one support unit 31, which extends over the entire length of the production line 1.

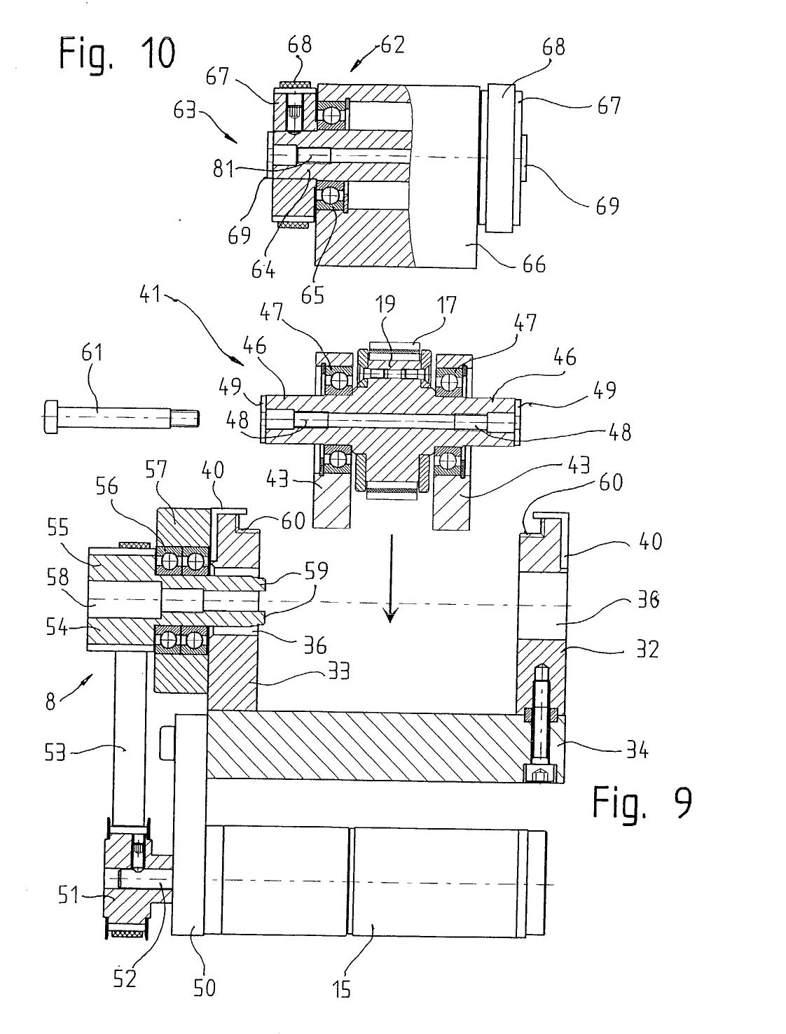

The support unit 31 includes a first side wall 32 and a second side wall 33, which are connected together by means of a first plate 34 and a second plate 35. Passage openings 36, 37, which serve for the first transfer drive 8 or the first coupling device 7, are provided at the side walls 32, 33. Pins 38 and threaded openings 39 are provided at the plates 34, 35. Removable brackets 40, which serve for guidance of the workpiece carriers 2, are arranged at the side walls 32, 33. Without the brackets 40, the workpiece carriers 2 can be removed from above (see FIG. 9).

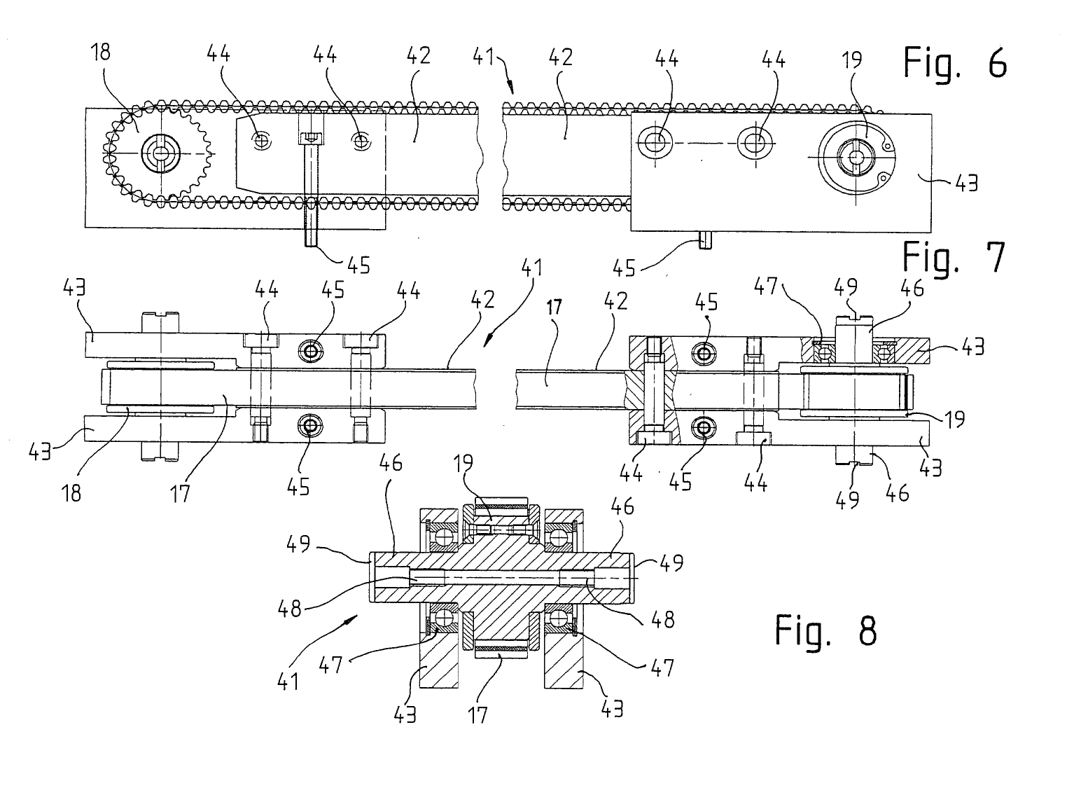

FIG. 6 and FIG. 7 show a belt module 41, which is insertable into the support unit 31. The belt module 41 consists of a strut 42, at each end and each side of which there is arranged a respective cheek member 43. The cheek members 43 per strut end are fixedly clamped at the strut end by means of bolts 44, wherein the cheek members 43 serve, at the respective strut ends, as a support for the first gearwheel 18 and for the second gearwheel 19. The belt module 41 is detachably connected with the support unit 31 by means of bolts 45, wherein the bolts 45 fit in the threaded openings 39 in the plates 34.

FIG. 8 shows a section through the second gearwheel 19. A wheel axle 46 of the gearwheel 19 is mounted on the cheek members 43 by means of bearings 47. A respective threaded opening 48 and respective slot 49 are provided at each axle end.

FIG. 9 shows a transfer drive 8, 12 or an interchange drive 14, which is arranged at the support unit 31. The first drive motor 15 is arranged at a bracket 50 which is connected to the plate 34 of the support unit 31. A drive pulley 51 transmits the rotational movement of the motor shaft 52 by means of a cogged belt 53 to a driven pulley 54, the axle 55 of which is mounted at bearings 56 of a bearing block 57. The bearing block 57 is connected to a side wall 32, 33 of the support unit 31, wherein the pulley axle 55 extends through the passage opening 36. A bore 58 is provided at one end of the pulley axle 55 and dogs 59 are provided at the other end of the pulley axle 55. Protrusions of the side walls 32, 33 are denoted by 60 and form, together with the corresponding brackets 40, the guide for the workpiece carriers.

The belt module 41 of FIG. 8 is inserted from above into the support unit 31, wherein the slots 49 of the wheel axle 46 and the dogs 59 of the pulley axle 55 are vertically aligned. The dogs 59 then fit in the slots 49, whereby the gearwheel 19 of the belt module 41 is coupled to the transfer drive 8. For centering, a bolt 61 can in addition be inserted into the bore 58 of the pulley axle 55 and be screwed together with the threaded opening 48 of the wheel axle 46. After the insertion of the belt module 41 the bolts 45 of the belt module 41 are tightened. The belt module 41 can be inserted or removed without demounting the transfer drive 8.

FIG. 10 shows a deflecting wheel 62 of a belt drive 63 for the return run of the workpiece carriers 2. The wheel axle 64, which is provided with a threaded opening 81, is constructed at its ends in a comparable manner with the wheel axle 46 of the gearwheel 19. The wheel axle 64, which is supported in a housing 66 by means of bearings 65, has at each end a respective belt pulley 67 by means of which a flat belt 68 is deflectable. The belt drive 63 can be inserted, instead of the belt module 41, into the equipment according to FIG. 9. The dogs 59 of the pulley axle 55 fit in the slots 69 provided at the ends of the wheel axle 64. The support unit 31 together with the drive 8 can thus also be used for construction of the return run device.

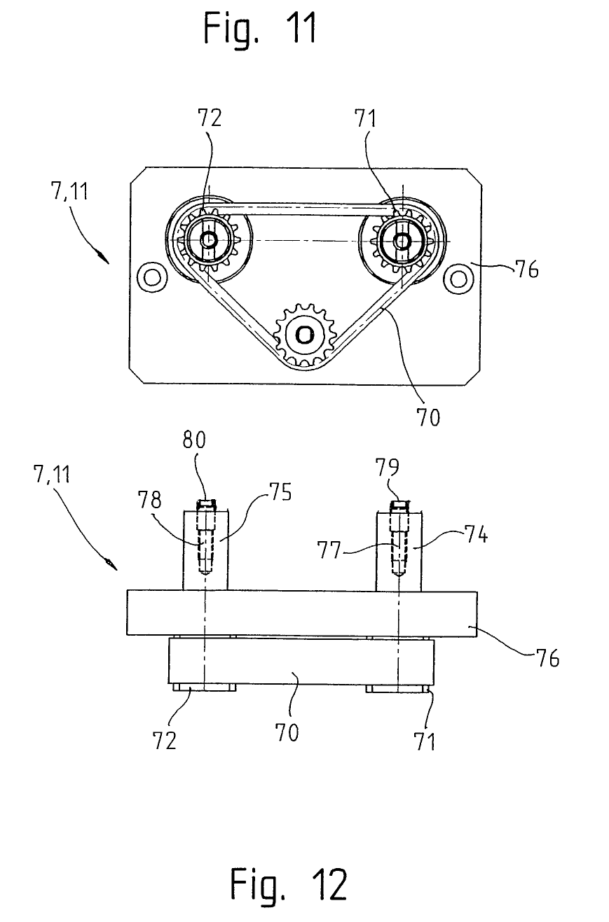

FIG. 11 and FIG. 12 show the first coupling device 7 for transmission of the belt movement of the belt 17 of the first transfer device 5 to the first extension 6, which in turn consists of a support unit 31 and a belt module 41. The extension 6 is part of the transfer device 5. A division of the length of the transfer device 5 is necessary due to the elasticity of the cogged belt 17 and the positional accuracy, which is associated therewith, of the workpiece supports 2. The second coupling device 11 is constructed in a comparable manner with the first coupling device 7. A cogged belt 70 is guided by way of gearwheels 71, 72 and by way of a tensioning wheel 73. The axles 74, 75 of the gearwheels 71, 72 are mounted on a support plate 76. The axles 74, 75 are constructed in a comparable manner with the pulley axle 55 and have respective bores 77, 78 and dogs 79, 80. The coupling device 7 can be arranged on the transfer drive side or on the opposite side at the side wall 32, 33, wherein the axle 74 or 75 penetrates the passage openings 36 of the transfer device and the extension. One axle 74 is driven by means of the dogs 79 of the first gearwheel 18 and the other axle 75 drives the gearwheel of the first extension 6 by means of the dogs 80.

We claim:

1. Equipment for the transfer of workpieces by means of workpiece carriers within a production line with at least one group of work stations, wherein the workpiece carriers are movable by means of at least one transfer device, characterised in that the transfer device comprises a support unit and a belt module insertable in the support unit, wherein a transfer drive is arranged at the support unit and drives at least one belt which moves the workpiece carriers.

2. The equipment according to claim 1, characterised in that the belt module comprises a strut and cheek members arranged at ends of the strut, the strut and cheek members serving as a support for gearwheels driving and deflecting the belt.

3. The equipment according to claim 1 or 2, characterised in that the support unit comprises side walls and plates connecting the side walls, wherein the belt module is detachably connectible with the plates.

4. The equipment according to claim 3, characterised in that the transfer drive is arranged at a side wall of the support unit and comprises a pulley axle for a driven pulley, the axle extending through a passage opening of a side wall and having dogs at a free end.

5. The equipment according to claim 4 further comprising a wheel axle of a gearwheel has at each end a respective slot in which the dogs of the pulley axle engage on insertion of the belt module into the support unit.

6. The equipment according to any claim 3, further comprising at least one coupling device for transfer of belt movement of the belt to a further belt is provided and is mountable on a side wall of the support unit.

7. The equipment according to claim 6, characterised in that the coupling device comprises belt-driven wheels having axles which each extend through a respective passage opening of a side wall and each axle has, at a free end, dogs which engage in slots of a wheel axle of a gearwheel of the belt module when the belt module is inserted into the support unit.
